(19) United States
(12) Patent Application Publication
(10) Pub. No.: US 2025/0247662 A1
(43) Pub. Date: Jul. 31, 2025

(54) METHOD FOR PROVIDING CONTENT, AND DISPLAY DEVICE

(71) Applicant: Samsung Electronics Co., Ltd., Suwon-si (KR)

(72) Inventors: Iaesung PARK, Suwon-si (KR); Seongsu PARK, Suwon-si (KR)

(21) Appl. No.: 19/086,803

(22) Filed: Mar. 21, 2025

Related U.S. Application Data
(63) Continuation of application No. PCT/KR2023/013579, filed on Sep. 11, 2023.

(30) Foreign Application Priority Data
Oct. 18, 2022 (KR) 10-2022-0134466
Jan. 25, 2023 (KR) 10-2023-0009540

(51) Int. Cl. H04S 7/00

(52) U.S. Cl. CPC H04S 7/301; H04S 7/303

(57) ABSTRACT

An example method, performed by a display device, of providing content may include obtaining video content representing a virtual space, obtaining first audio content corresponding to the video content, obtaining spatial information representing audio-related characteristics of a user space, generating second audio content, which is spatially customized audio content, by converting the first audio content based on metadata of the video content, metadata of the first audio content, and the spatial information, obtaining at least one of positions or specifications of one or more speakers connected to the display device, determining output settings of the one or more speakers for the second audio content, based on the at least one of the positions of the one or more speakers or the specifications of the one or more speakers, and the spatial information, and outputting the second audio content based on the output settings while the video content is displayed.

### CROSS-REFERENCE TO RELATED APPLICATIONS

This application is a continuation of International Application No. PCT/KR2023/013579, designating the United States, filed on Sep. 11, 2023, in the Korean Intellectual Property Receiving Office, and claiming priority to Korean Patent Application Nos. 10-2022-0134466 filed on Oct. 18, 2022 and 10-2023-0009540 filed on Jan. 25, 2023, in the Korean Intellectual Property Office, the disclosures of each of which are incorporated by reference herein in their entireties.

### BACKGROUND

### Field

The disclosure relates to a display device and an operation method thereof for providing content including spatially customized audio optimized for a user.

### Description of Related Art

Various technologies/techniques such as virtual reality, augmented reality, etc. are being developed to display virtual spaces using computer graphics. A user may be presented with a visually immersive virtual space via a display device, but audio content corresponding to the virtual space may not reflect various environmental factors in the user's real-word space.

To solve this problem, various algorithms have recently been used to provide an enhanced virtual space experience by providing immersive audio optimized according to spatial information of a user's space.

### SUMMARY

According to an embodiment of the present disclosure, a method, performed by a display device, of providing content may include obtaining video content representing a virtual space; obtaining first audio content corresponding to the video content; obtaining spatial information representing audio-related characteristics of a user space; generating second audio content by converting the first audio content based on metadata of the video content, metadata of the first audio content, and the spatial information, wherein the second audio content may be spatially customized audio content; obtaining at least one of positions or specifications of one or more speakers connected to the display device; determining output settings of the one or more speakers for the second audio content, based on the spatial information and at least one of the positions of the one or more speakers or the specifications of the one or more speakers; and outputting the second audio content based on the output settings while the video content is displayed on a screen of the display device.

According to an embodiment of the present disclosure, a display device may include a communication interface, a display, memory storing one or more instructions, and at least one processor configured to execute the one or more instructions stored in the memory. The at least one processor may be configured to control the display device to obtain video content representing a virtual space; obtain first audio content corresponding to the video content; obtain spatial information representing audio-related characteristics of a user space; generate second audio content, which is spatially customized audio content obtained by being converted into a sound optimized for the user space according to the spatial information, by converting the first audio content based on metadata of the video content, metadata of the first audio content, and the spatial information; obtain at least one of positions or specifications of one or more speakers connected to the display device; determine output settings of the one or more speakers for the second audio content, based on the at least one of the positions of the one or more speakers or the specifications of the one or more speakers, and the spatial information; and output the second audio content based on the output settings while the video content is displayed on a screen of the display device.

According to an embodiment of the present disclosure, a non-transitory computer-readable recording medium having recorded thereon a program which, when executed, controls a display device to perform operations, performed by a display device, of providing content, as described above and below, may be provided.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a schematic diagram illustrating an example display device providing content, according to various embodiments of the present disclosure;

FIG. 2 is a flowchart illustrating an example method, performed by an example display device, of providing content, according to various embodiments of the present disclosure;

FIG. 3 is a diagram illustrating example operations in which an example display device generates second audio content that is spatially customized audio content, according to various embodiments of the present disclosure;

FIG. 4 is a diagram illustrating an example user space in which an example display device is located, according to various embodiments of the present disclosure;

FIG. 5 is a flowchart illustrating an example operation in which an example display device generates audio metadata, according to various embodiments of the present disclosure.

FIG. 6 is a diagram illustrating an example operation in which an example display device generates second audio content, according to various embodiments of the present disclosure;

FIG. 7 is a diagram illustrating an example operation in which an example display device adjusts second audio content based on speaker specifications, according to various embodiments;

FIG. 8 is a diagram illustrating an example operation in which an example display device determines positions of one or more speakers, according to various embodiments of the present disclosure;

FIG. 9 is a diagram illustrating an example operation in which an example display device obtains a user's position, according to various embodiments of the present disclosure;

FIG. 10 is a diagram illustrating an example operation in which an example display device updates a user's position, according to various embodiments of the present disclosure;

FIG. 11 is a block diagram of a configuration of an example display device according to various embodiments of the present disclosure;

FIG. 12 is a block diagram of a configuration of an example display device according to various embodiments of the present disclosure; and

FIG. 13 is a block diagram illustrating modules used by an example display device, according to various embodiments of the present disclosure.

### DETAILED DESCRIPTION

Throughout the present disclosure, the expression “at least one of a, b or c” indicates only a, only b, only c, both a and b, both a and c, both b and c, all of a, b, and c, or variations thereof.

The terms used in the present disclosure may be general terms currently widely used in the art by taking into account functions described herein, but may vary according to an intention of a technician engaged in the art, precedent cases, advent of new technologies, etc. Furthermore, specific terms may be arbitrarily selected by the applicant, and, in this case, the meaning of the selected terms will be described in detail in the relevant description. Thus, the terms used herein should be defined not by simple appellations thereof but based on the meaning of the terms together with the overall description of the present disclosure.

Singular expressions used herein are intended to include plural expressions as well unless the context clearly indicates otherwise. All the terms used herein, which include technical or scientific terms, may have the same meaning that is generally understood by one of ordinary skill in the art. Furthermore, although the terms including an ordinal number such as “first”, “second”, etc. may be used herein to describe various elements or components, these elements or components should not be limited by the terms. The terms are only used to distinguish one element or component from another element or component.

Throughout the specification, when a part “includes” or “comprises” an element, unless there is a particular description contrary thereto, it is understood that the part may further include other elements, not excluding the other elements. In addition, terms such as “unit”, “module”, etc., described herein refer to a unit for processing at least one function or operation and may be implemented as hardware (including, e.g., circuitry) or software, or a combination of hardware and software.

Embodiments of the present disclosure will be described more fully hereinafter with reference to the accompanying drawings so that they may be easily implemented by one of ordinary skill in the art. However, the present disclosure may be implemented in many different forms and should not be construed as being limited to example embodiments set forth herein. Furthermore, parts not related to the descriptions may be omitted to clearly explain the present disclosure in the drawings, and like reference numerals denote like elements throughout. In addition, reference numerals used in each drawing are only intended to describe each drawing, and different reference numerals used in different drawings are not intended to indicate different elements. Hereinafter, the present disclosure is described in detail with reference to the accompanying drawings.

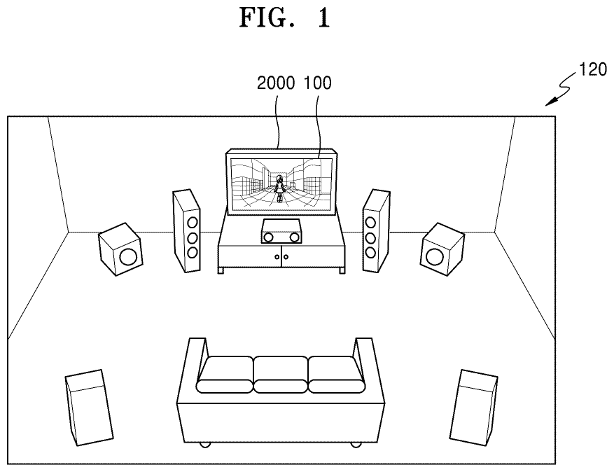

FIG. 1 is a schematic diagram illustrating an example display device providing content, according to various embodiments of the present disclosure.

Referring to FIG. 1, a display device 2000 according to an embodiment may be located in a user space 120. In addition, one or more speakers connected to the display device 2000 may be located in the user space 120. The display device 2000 may display, for example, video content representing a virtual space 100 via a screen. In addition, the one or more speakers may play audio content corresponding to the video content representing the virtual space 100.

In an embodiment, the display device 2000 may process audio content corresponding to the virtual space 100 to provide an immersive experience in the virtual space 100 to a user. In detail, the display device 2000 may modify the audio content corresponding to the virtual space to spatially customized audio content (also referred to as immersive audio content in the present disclosure) for the user space 120. For example, the display device 2000 may analyze the video content and metadata of the video content, and generate immersive audio content using a result of the analysis. For example, the display device 2000 may analyze audio and metadata of the audio content, and generate immersive audio content using a result of the analysis. For example, the display device 2000 may obtain spatial information representing audio-related characteristics of the user space 120, and generate immersive audio content using the spatial information. For example, the display device 2000 may obtain specifications and positions of the one or more speakers connected to the display device 2000, and generate immersive audio content based on the specifications and positions of the one or more speakers. The above-described examples of data/information used by the display device 2000 to generate immersive audio content do not have to be applied independently of each other. In an embodiment, two or more of the above-described examples may be combined.

Hereinafter, specific operations in which the display device 2000 generates and provides immersive audio using various pieces of information/data are described in more detail with reference to the following drawings and descriptions thereof. In addition, hereafter, audio content prior to being processed by the display device 2000 is referred to, for example, as first audio content, and immersive audio content is referred to, for example, as second audio content.

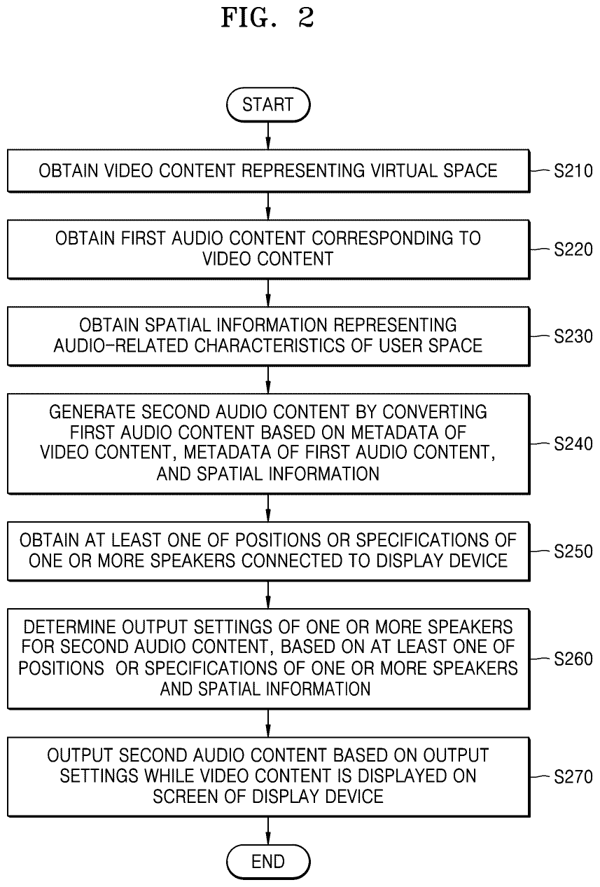

FIG. 2 is a flowchart illustrating an example method, performed by an example display device, of providing content, according to various embodiments of the present disclosure.

In operation S210, according to an embodiment, the display device 2000 obtains video content representing a virtual space.

In an embodiment, the video content may be content representing a virtual space. The video content may be, for example, video games, metaverse graphics, etc., but is not limited thereto. The display device 2000 may load video content stored in an internal memory of the display device 2000, or receive video content from an external device (e.g., a server, etc.).

In an embodiment, the video content may include metadata of the video content. The metadata of the video content may include, but is not limited to, at least one of a type of an object present in the video content, a location where a sound is generated, a trajectory of movement of an object, a place, or a time of day.

In operation S220, according to an embodiment, the display device 2000 obtains first audio content corresponding to the video content. The first audio content corresponding to the video content may be audio content provided together when the video content is provided. The first audio content may include, for example, but is not limited to, a background sound, a sound of an object in the virtual space, a sound input by a user, a sound input by a user other than the user in the virtual space, etc.

In an embodiment, the first audio content may include metadata of the first audio content. The metadata of the first audio content may include, but is not limited to, at least one of a time of appearance/disappearance of sounds, sound loudness, a position of an object in the virtual space, a trajectory of movement of a position of an object, a type of an object, or a sound corresponding to an object.

In an embodiment, the display device 2000 may identify whether the metadata of the first audio content exists. The display device 2000 may generate the metadata of the first audio content based on identifying that the metadata of the first audio content does not exist. For example, the display device 2000 may generate metadata of the first audio content by analyzing the video content and/or the first audio content.

In addition, the video content and the first audio content may be a single integrated content. That is, the integrated content may include the video content and the first audio content. In this case, metadata of the integrated content may include the metadata of the video content and the metadata of the first audio content in an integrated or separate form. Hereinafter, operations of the display device 2000 using the video content, the metadata of the video content, the first audio content, and the metadata of the first audio content may be equally applied to integrated content.

In operation S230, according to an embodiment, the display device 2000 obtains spatial information representing audio-related characteristics of a user space.

The user space refers to, for example, a real-world space of a user using the display device 2000. The user space may be, for example, an audio room in which the display device 2000 is located, but is not limited thereto.

In an embodiment, the spatial information may include information representing audio-related characteristics of the user space. The spatial information may include, for example, but is not limited to, at least one of information about a three-dimensional (3D) spatial layout, information about objects in the space, or information related to a bass trap, a sound absorber, and a sound diffuser in the space. The information about the 3D spatial layout may include, but is not limited to, information such as an area of the space, floor height, locations and sizes of walls, columns, doors/windows, etc. The information about the objects in the space may include, but is not limited to, information about sizes, positions, shapes, etc. of various objects present in the space, such as tables, chairs, speakers, and TV stands. The information about the bass trap, sound absorber, and sound diffuser in the space may include, but is not limited to, the size, position, direction, etc. of the sound absorber and/or sound diffuser installed in the user space.

In operation S240, according to an embodiment, the display device 2000 generates second audio content by converting the first audio content based on metadata of the video content, metadata of the first audio content, and the spatial information.

In an embodiment, the second audio content may be spatially customized content. Spatially customized audio content may be audio content that is obtained by being converted into a sound optimized for the user space by reflecting the spatial information of the user space. For example, the user may experience the virtual space using the display device 2000 and one or more speakers in the user space. In this case, the second audio content is immersive audio content obtained by converting a sound played in the virtual space so that the sound may be realistically delivered to the user in the user space.

Based on the metadata of the video content and the metadata of the first audio content, the display device 2000 may change output loudness, output direction, output location, etc. of a sound generated within the virtual space (e.g., a sound output from an object within the virtual space). Specific operations in which the display device 2000 generates second audio content are described below with reference to the following drawings.

In operation S250, according to an embodiment, the display device 2000 obtains at least one of positions or specifications of one or more speakers connected to the display device 2000. The one or more speakers may be multi-channel speakers. For example, the one or more speakers may be speakers in a 5.1 channel configuration capable of providing surround sound, but are not limited thereto.

In an embodiment, the display device 2000 may include one or more microphones. The display device 2000 may receive a test sound from the one or more speakers using the one or more microphones. The display device 2000 may determine positions and directions of the one or more speakers based on the received test sound. In an embodiment, the display device 2000 may receive a user input for inputting a position of the one or more speakers.

In an embodiment, the display device 2000 may obtain identification information (e.g., a model name, an identification number, etc.) of the one or more speakers connected to the display device 2000. Based on the identification information of the one or more speakers, the display device 2000 may retrieve specification information of the speakers corresponding to the identification information from a database. In an embodiment, the display device 2000 may receive a user input for inputting specifications of the one or more speakers.

In operation S260, according to an embodiment, the display device 2000 determines output settings of the one or more speakers for the second audio content, based on the positions of the one or more speakers or the specifications of the one or more speakers and the spatial information.

The display device 2000 may determine the output settings of the one or more speakers for the second audio content based on the spatial information and the positions or specifications of the one or more speakers, thereby providing immersive audio tailored to characteristics of the user space. For example, even when speakers with the same specifications are installed in a first space of a first user and a second space of a second user, different output settings may be determined for the first space of the first user and the second space of the second user because spatial information representing characteristics of each user's space and positions of the speakers in each user's space are different.

In operation S270, according to an embodiment, the display device 2000 outputs the second audio content based on the output settings while the video content is displayed on a screen of the display device. The user of the display device 2000 may have a virtual space experience via the video content and the second audio content.

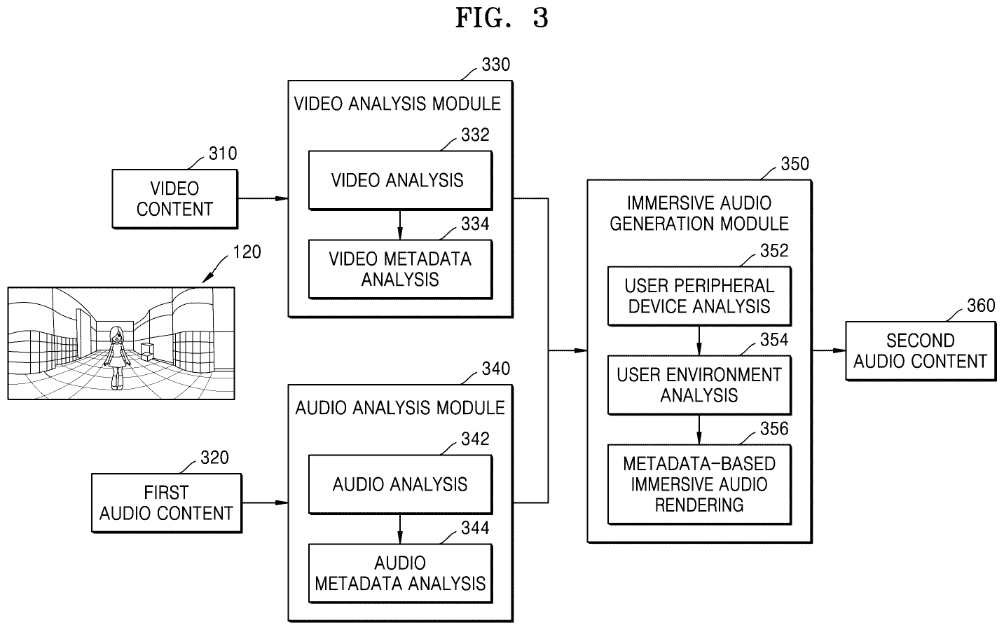

FIG. 3 is a diagram illustrating example operations in which an example display device generates second audio content that is spatially customized audio content, according to various embodiments of the present disclosure.

In an embodiment, the display device 2000 may obtain video content 310 and first audio content 320. The video content 310 corresponds to graphics in the virtual space 100, and the first audio content 320 corresponds to sounds in the virtual space 100.

According to an embodiment, the display device 2000 may perform video analysis 332 on the video content 310 using a video analysis module 330. The display device 2000 may obtain various pieces of data for modifying the first audio content 320 to second audio content 360 using various known video analysis algorithms. To perform the video analysis 332, the display device 2000 may use various known deep neural network (DNN) architectures and algorithms, or may use an artificial intelligence (AI) model implemented through modifications to the various known DNN architectures and algorithms.

For example, the display device 2000 may detect and recognize one or more objects in scenes included in the video content 310. Additionally or alternatively, the display device 2000 may categorize the scenes in the video content 310. Additionally or alternatively, the display device 2000 may detect a skeleton of a person in a video and categorize an action of the person based on the detected skeleton. Additionally or alternatively, the display device 2000 may detect and recognize a face of the person in the video. Additionally or alternatively, the display device 2000 may extract two-dimensional (2D)/3D distance information (e.g., depth information) in the video.

According to an embodiment, the display device 2000 may perform video metadata analysis 334 on the video content 310 using the video analysis module 330. Video metadata may be configured in a data format including predefined data elements, but is not limited thereto. The video metadata may include, for example, but is not limited to, at least one of a type of an object present in the video content 310, a location where a sound is generated, a trajectory of movement of an object, a place, or a time of day. Additionally or alternatively, information related to a sound in the video metadata may be provided as audio metadata rather than video metadata.

In an embodiment, when the display device 2000 obtains the video content 310, the video metadata corresponding to the video content 310 may be obtained together therewith. In an embodiment, the video metadata may be generated by the display device 2000. The display device 2000 may generate and update the video metadata based on a result of the video analysis 332 described above.

The display device 2000 may perform audio analysis 342 on the first audio content 320 using an audio analysis module 340. The display device 2000 may obtain various pieces of data for modifying the first audio content 320 to the second audio content 360 using various known video analysis algorithms. To perform the audio analysis 334, the display device 2000 may use various known DNN architectures and algorithms, or use an AI model implemented through modifications to the various known DNN architectures and algorithms.

For example, the display device 2000 may identify sound events included in the first audio content 320. The display device 2000 may identify, in the first audio content 320, times of appearance and disappearance of sounds and sound loudness. Additionally or alternatively, the display device 2000 may classify events corresponding to sounds.

The display device 2000 may perform audio metadata analysis 344 on the first audio content 320 using the audio analysis module 340. Audio metadata of audio content may be configured in a data format including predefined data elements, but is not limited thereto. The audio metadata may include, for example, but is not limited to, at least one of a time of appearance/disappearance of sounds, sound loudness, a position of an object in the virtual space, a trajectory of movement of a position of an object, a type of an object, or a sound corresponding to an object.

In an embodiment, when the display device 2000 obtains the first audio content 320, the audio metadata corresponding to the first audio content 320 may be obtained together therewith. In an embodiment, the display device 2000 may supplement and update the audio metadata based on a result of the audio analysis 342.

The data processing results from the video analysis module 330 and the audio analysis module 340 are transmitted to an immersive audio generation module 350.

In an embodiment, the immersive audio generation module 350 may generate the second audio content 360, which is immersive audio, by converting the first audio content 320 based on at least one of the metadata of the video content 310, the metadata of the first audio content 320, or spatial information.

In an embodiment, the display device 2000 may perform user peripheral device analysis 352 using the immersive audio generation module 350. User peripheral devices may include one or more speakers. Specifications of the one or more speakers may include, for example, but are not limited to, driver units (e.g., 2-way, 3-way, etc.), frequency response, sound pressure level (SPL), amplifier power output, impedance, sensitivity, vertical/horizontal coverage angle, etc.

The display device 2000 may analyze specifications and positions of one or more speakers. For example, the display device 2000 may determine, based on the specifications of the one or more speakers, a frequency band in which the first audio content 320 is to be separately output from each speaker. For example, the display device 2000 may determine which of the one or more speakers a sound of the first audio content is to be output from, based on a distance and a direction from the display device 2000 to the one or more speakers. A result of the user peripheral device analysis 352 may be used to perform metadata-based immersive audio rendering 356.

In an embodiment, the display device 2000 may perform user environment analysis 354 using the immersive audio generation module 350. A user environment may include, but is not limited to, spatial information of a user space in which the display device 2000 is installed, a user's position, etc. In addition, the spatial information may include, but is not limited to, at least one of information about a 3D spatial layout, information about objects in the space, or information related to a bass trap, a sound absorber, and a sound diffuser in the space.

The display device 2000 may analyze audio-related characteristics of the user environment. For example, the display device 2000 may calculate a degree of sound absorption and a degree of sound reflection according to a direction of a sound, based on layout information of the user space, information about a sound absorber installed in the user space, information about a sound diffuser installed therein, etc. For example, the display device 2000 may calculate information about a frequency range that is audible to the user based on the layout information of the user space and the user's position. The display device 2000 may calculate a listening distance (e.g., half a wavelength) at which low-band sound waves can be heard, and/or a lowest frequency that is audible in the user space. Specifically, if the speed of sound is 340 meters per second (m/s) and a listening distance from a speaker to the user in the user space is 5 m, a wavelength of a sound signal audible at the user's position may be calculated as 10 m. In this case, the lowest frequency that can be accurately heard in the user space may be determined as the speed of sound/wavelength, i.e., 340 m/s/10 m=34 hertz (Hz). A result of the user environment analysis 354 may be used to perform the metadata-based immersive audio rendering 356.

In an embodiment, the display device 2000 may perform the metadata-based immersive audio rendering 356 using the immersive audio generation module 350. The display device 2000 may render the second audio content 360, which is immersive audio, based on the metadata of the video content 310 and the metadata of the first audio content 320. For example, the display device 2000 may map the first audio content 320 to objects existing in the virtual space of the video content 310 based on the metadata of the video content 310 (e.g., type of objects present in the video content, location of sound generation, trajectory of object movement, place, time of day, etc.) and the metadata of the first audio content 320 (e.g., time of appearance/disappearance of sounds, sound loudness, positions of objects in the virtual space, trajectory of object position movement, type of objects, etc.). The display device 2000 may render output loudness, output direction, output location, etc. of sounds generated within the virtual space of the video content 310, based on the arrangement, distance, and orientation of the objects existing in the virtual space.

In an embodiment, information in the metadata of the video content 310 may be supplemented or updated based on the result of the video analysis 332. The display device 2000 may perform the metadata-based immersive audio rendering 356 based on the result of the video analysis 332, and render the second audio content 360. For example, at least one of the type of objects present in the video content 310, the location of sound generation, the trajectory of object movement, the place, or the time of day, which is obtained as the result of the video analysis 332, may be used.

In an embodiment, information in the metadata of the first audio content 342 may be supplemented or updated based on the result of the audio analysis 342. The display device 2000 may perform the metadata-based immersive audio rendering 356 based on the result of the audio analysis 342, and render the second audio content 360. For example, at least one of the time of appearance and disappearance of sounds in the first audio content 310, sound loudness, or classification of events corresponding to sounds, which is obtained as the result of the audio analysis 332, may be used.

In an embodiment, the result of the user peripheral device analysis 352 may be used when the display device 2000 performs the metadata-based immersive audio rendering 356. The display device 2000 may generate the second audio content 360 by changing attribute values of the sound based on the specifications of the one or more speakers connected to the display device 2000 (e.g., driver units (e.g., 2-way, 3-way, etc.), frequency response, SPL, amplifier power output, impedance, sensitivity, vertical/horizontal coverage angle, etc.)

In an embodiment, the result of the user environment analysis 354 may be used when the display device 2000 performs the metadata-based immersive audio rendering 356. The display device 2000 may generate the second audio content 360 by changing attribute values of the sound based on the spatial information of the user space where the display device 2000 is installed, the user's position, etc.

In addition, the examples of operations of the metadata-based immersive audio rendering 356 described above are not limited to being performed independently of each other. The display device 2000 may perform the metadata-based immersive audio rendering 356 by combining two or more of the examples. For example, the display device 2000 may perform the metadata-based immersive audio rendering 356 based on a combination of at least two of the video analysis 332, the video metadata analysis 334, the audio analysis 342, the audio metadata analysis 344, the user peripheral device analysis 352, and the user environment analysis 354.

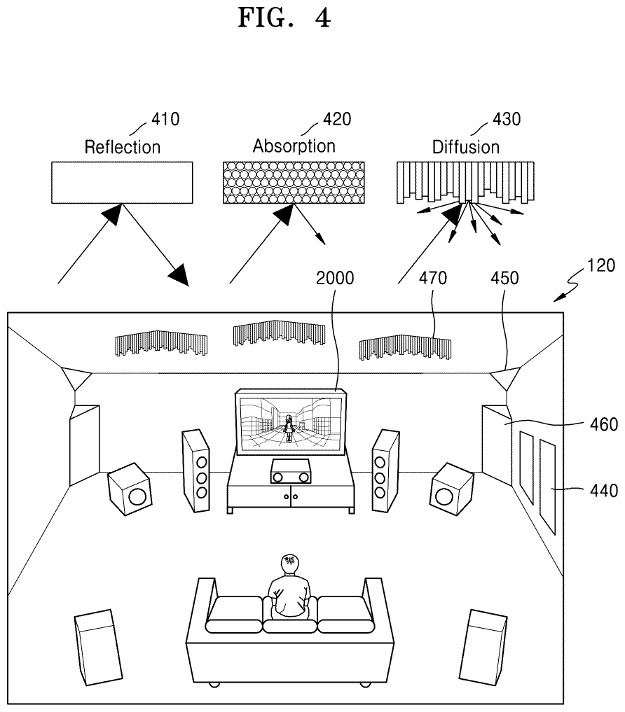

FIG. 4 is a diagram illustrating an example user space in which an example display device is located, according to various embodiments of the present disclosure.

In an embodiment, a user space 120 with the display device 2000 may be an audio room. The display device 2000 may obtain spatial information representing audio-related characteristics of the user space 120.

In an embodiment, the audio-related characteristics of the user space 120 may refer to, for example, reflection 410, absorption 420, and diffusion 430. As illustrated in FIG. 4, reflection 410 refers to a characteristic of reflecting an input sound, absorption 420 refers to a characteristic of absorbing at least a portion of an input sound, and diffusion 430 refers to a characteristic of diffusing an input sound.

In an embodiment, sound absorbers 440 may be present in the user space 120. The sound absorbers 440 may absorb sound in a mid-frequency band that is reflected well. For example, the sound absorbers 440 may be installed on, for example, a wall in the user space 120. However, this is an illustrative drawing for convenience of description, and the audio-related characteristics of the user space 120 are not limited thereto. The display device 2000 may obtain information related to the sound absorbers 440. For example, the display device 2000 may obtain information related to a location, size, direction, frequency band absorbed by the sound absorbers 440, etc. In the above description, when the display device 2000 converts first audio content into second audio content, the display device 2000 may use the information related to the sound absorbers 440. In detail, the display device 2000 may enhance or attenuate a specific frequency band in the first audio content, but is not limited thereto.

In an embodiment, bass traps 450 and 460 may be present in the user space 120. The bass traps 450 and 460 may absorb low-frequency sounds having large wavelengths to offset the energy of the low-frequency sounds. The user space 120 may include, for example, the first bass traps 450 at vertices where walls meet a ceiling and the second bass traps 460 in corners where the walls meet each other. However, this is an illustrative drawing for convenience of description, and the audio-related characteristics of the user space 120 are not limited thereto. The display device 2000 may obtain information related to the bass traps 450 and 460. For example, the display device 2000 may obtain information related to locations, sizes, directions, frequency bands absorbed by the bass traps 450 and 460, etc. In the above description, when the display device 2000 converts the first audio content into the second audio content, the display device 2000 may use the information related to the bass traps 450 and 460.

In an embodiment, sound diffusers 470 may be present in the user space 120. The sound diffusers 470 may disperse high-frequency sounds having relatively low energy. For example, the sound diffusers 470 may be present on the ceiling in the user space 120. However, this is an illustrative drawing for convenience of description, and the audio-related characteristics of the user space 120 are not limited thereto. The display device 2000 may obtain information related to the sound diffusers 470, (e.g., information related to a location, size, direction, and frequency band diffused). In the above description, when the display device 2000 converts first audio content into second audio content, the display device 2000 may use the information related to the sound diffusers 470.

In an embodiment, the audio-related characteristics of the user space 120 may include information about a 3D spatial layout and information related to objects in the space. The information about the 3D spatial layout may include, but is not limited to, information such as an area of the space, floor height, locations and sizes of walls, columns, doors/windows, etc. The information about the objects in the space may include, but is not limited to, information about sizes, positions, shapes, etc. of various objects present in the space, such as tables, chairs, speakers, TV stands, etc. In the above description, when the display device 2000 converts the first audio content into the second audio content, the display device 2000 may use the information about the 3D spatial layout and the information related to the objects in the space.

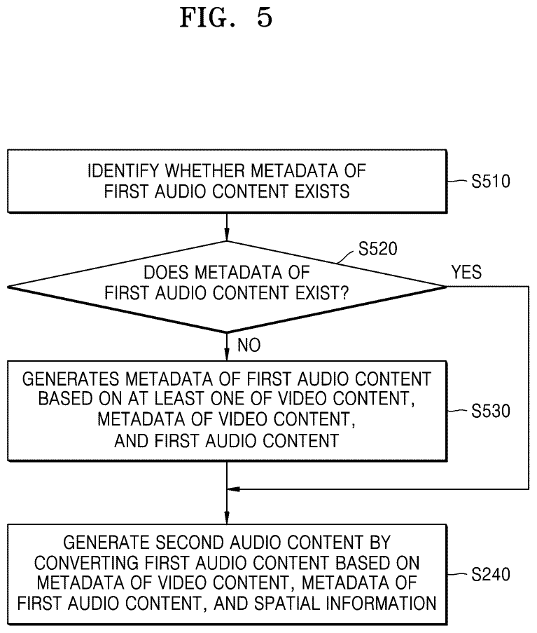

FIG. 5 is a flowchart illustrating an example operation in which an example display device generates audio metadata, according to various embodiments of the present disclosure.

Referring to FIG. 5, operations of FIG. 5 may be performed, for example, at least before operation S240 of FIG. 2 is performed.

In operation S510, the display device 2000 identifies whether metadata of the first audio content exists. For example, the display device 2000 may obtain the first audio content corresponding to the video content and identify whether metadata of the first audio content exists. When all or some of the metadata of the first audio content does not exist, the display device 2000 may determine whether to generate metadata of the first audio content.

In operation S520, when the metadata of the first audio content exists, the display device 2000 may perform operation S240 of FIG. 2 using the metadata of the first audio content. For example, when the metadata of the first audio content exists, the display device 2000 may perform operation S530 to update the metadata of the first audio content.

When the metadata of the first audio content does not exist, the display device 2000 may perform operation S530.

In operation S530, the display device 2000 generates the metadata of the first audio content based on at least one of the video content, metadata of the video content, or the first audio content.

The display device 2000 may analyze at least one of the video content, the metadata of the video content, or the first audio content, and generate the metadata of the first audio content based on a result of the analysis. For example, the display device 2000 may obtain a type of an object present in the video content, a location of sound generation, a trajectory of movement of an object, a place, a time of day, etc. by analyzing the video content and/or the metadata of the video content, and obtain a time of appearance/disappearance of sounds, sound loudness, an event corresponding to a sound, etc. by analyzing the audio content. Based on the result of analyzing the video content, the metadata of the video content, and the audio content, the display device 2000 may generate the metadata of the first audio content (e.g., a time of appearance/disappearance of sounds, sound loudness, a position of an object in the virtual space, a trajectory of movement of a position of an object, a type of an object, a sound corresponding to an object, etc.).

After operation S530 is performed, operations S240 to S270 of FIG. 2 may be performed. Because this has been described above in the description with respect to FIG. 2, a redundant description thereof is not repeated for brevity.

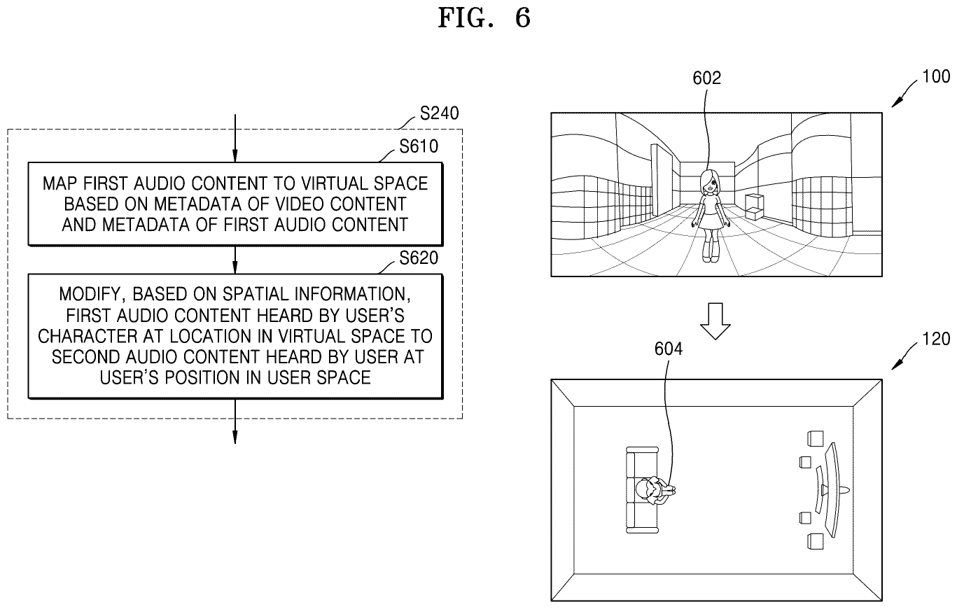

FIG. 6 is a diagram illustrating an example operation in which an example display device generates second audio content, according to various embodiments of the present disclosure.

Referring to FIG. 6, operations S610 and S620 may, for example, correspond to operation S240 of FIG. 2.

In operation S610, the display device 2000 maps the first audio content to the virtual space 100 based on metadata of the video content and metadata of the first audio content.

For example, the display device 2000 may map a sound corresponding to an object in the virtual space 100, based on at least one of a type, size, position, distance, or orientation of the object present in the virtual space 100 of the video content. For example, the display device 2000 may map a sound corresponding to an event based on a specific event occurring in the virtual space 100 of the video content. In this case, because the sound is mapped to a specific location and/or a specific object in the virtual space 100, the sound presented to the user may become louder or quieter, and the direction of the sound may change as a user's character 602 in the virtual space 100 approaches or moves away from the specific location and/or the specific object in the virtual space 100. In addition, the mapped sound may be output when the specific event occurs in the virtual space 100, thereby providing a realistic sound effect to the user.

In operation S620, the display device 2000 modifies, based on the spatial information, the first audio content heard by the user's character 602 at a position of the user's character 602 in the virtual space 100 to the second audio content heard by a user 604 at a position of the user 604 in the user space 120.

The display device 2000 may change characteristics of the audio. For example, the display device 2000 may change a frequency indicating the pitch of a sound, an amplitude indicating the intensity or loudness of the sound, output speaker information indicating a location where the sound is output, equalizer settings, etc., but is not limited thereto.

For example, when a first sound is generated in a first direction and at a first distance relative to the position of the user's character 602 in the virtual space 100, the display device 2000 may change characteristics of the first audio content as if the user 604 in the user space 120 hears the first sound from the first direction and at the first distance relative to the real-world position in the user space 120. Similarly, when a second sound is generated in a second direction and at a second distance relative to the position of the user's character 602 in the virtual space 100, the display device 2000 may change the characteristics of the first audio content as if the user 604 in the user space 120 hears the second sound from the second direction and at the second distance relative to the real-world position in the user space 120.

Because generating, by the display device 2000, the second audio content by modifying the first audio content has been described above in the description with respect to FIG. 3, a redundant description thereof is not repeated for brevity.

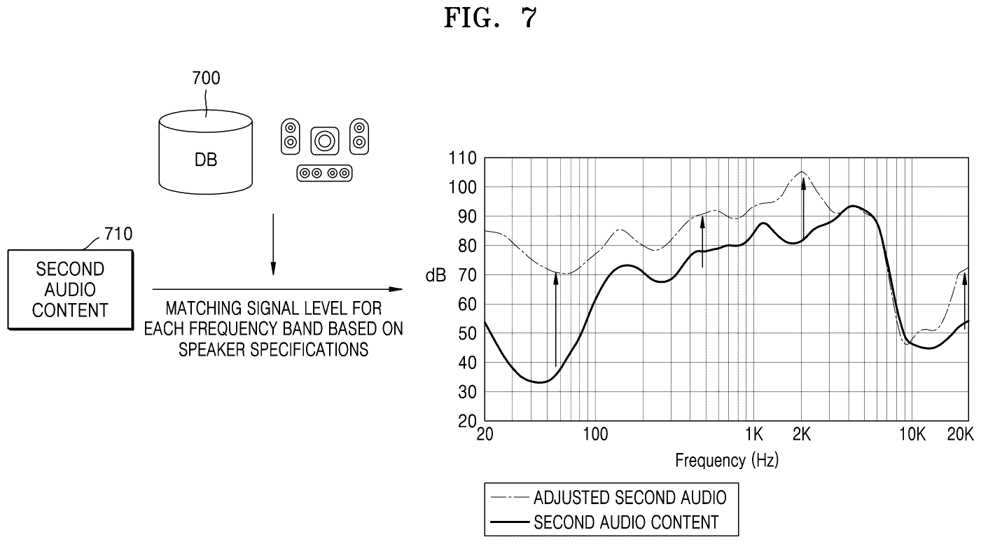

FIG. 7 is a diagram illustrating an example operation in which an example display device adjusts second audio content based on speaker specifications, according to various embodiments of the present disclosure.

Referring to FIG. 7, according to an embodiment, after generating second audio content 710, the display device 2000 may perform signal level matching for each frequency band of the second audio content 710 based on specifications of one or more speakers connected to the display device 2000.

In an embodiment, the display device 2000 may obtain identification information (e.g., a model name, an identification number, etc.) of the one or more speakers connected to the display device 2000. For example, a database 700 of the display device 2000 may store specification information based on types and model names of speakers. Based on the identification information of the one or more speakers, the display device 2000 may retrieve specification information of the speaker corresponding to the identification information from the database 700 of the display device 2000.

The display device 2000 may adjust, based on the identified speaker specifications, a signal level for each frequency band of the second audio content 710.

For example, the display device 2000 may generate the adjusted second audio content by enhancing and/or attenuating low/mid/high frequencies of the second audio content 710 based on the specifications of the one or more speakers.

For example, as a result of analyzing the specifications of the one or more speakers connected to the display device 2000, output performances of the one or more connected speakers may be different from each other. For example, a first speaker and a second speaker may be connected to the display device 2000, and the first speaker may have a higher output performance than the second speaker. In this case, based on the output performances of the one or more speakers being different from each other, the display device 2000 may adjust a signal level of the second audio content 710 so that a balanced sound is provided within the user space. In detail, the display device 2000 may reduce a signal level of the second audio content 710 to be played via the first speaker with a higher output performance, so that a balanced sound is output from the first speaker and the second speaker.

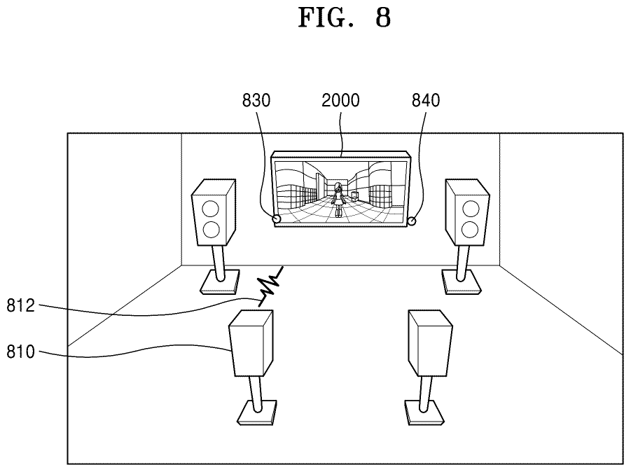

FIG. 8 is a diagram illustrating an example operation in which an example display device determines positions of one or more speakers, according to various embodiments of the present disclosure.

Referring to FIG. 8, the display device 2000 may calculate positions of one or more speakers connected to the display device 2000. The display device 2000 may include one or more microphones to calculate the positions of the one or more speakers.

For example, the display device 2000 may receive a test sound 812 from a first speaker 810. The test sound 812 may be received from a first microphone 830 and a second microphone 840 included in the display device 2000. The display device 2000 may calculate a distance and a direction from the display device 2000 to the first speaker 810 based on a difference between times when the test sound 812 is received by the first microphone 830 and the second microphone 840. The display device 2000 may receive the test sound from each of all speakers existing in the space and determine a position of each speaker.

In an embodiment, the display device 2000 may further use other sensors included in the display device 2000 to determine the positions of the one or more speakers. For example, the display device 2000 may use a time of flight (ToF) sensor, a red, green, blue (RGB) camera, a RGB-depth (RGB-D) camera, etc. to determine the positions of the one or more speakers.

In an embodiment, the display device 2000 may receive a user input for inputting the positions of the one or more speakers. The display device 2000 may verify and update the positions of the one or more speakers, which are input via the user input, based on the test sound 812. For example, the display device 2000 may update, based on a user input, the positions of the one or more speakers determined based on the test sound 812.

The display device 2000 may determine output settings of the one or more speakers for the second audio content based on the positions of the one or more speakers, thereby providing immersive audio tailored to the characteristics of the user space. For example, even when speakers with the same specifications are installed in a first space of a first user and a second space of a second user, different output settings may be determined for the first space of the first user and the second space of the second user because spatial information representing characteristics of each user's space and positions of the speakers in each user's space are different.

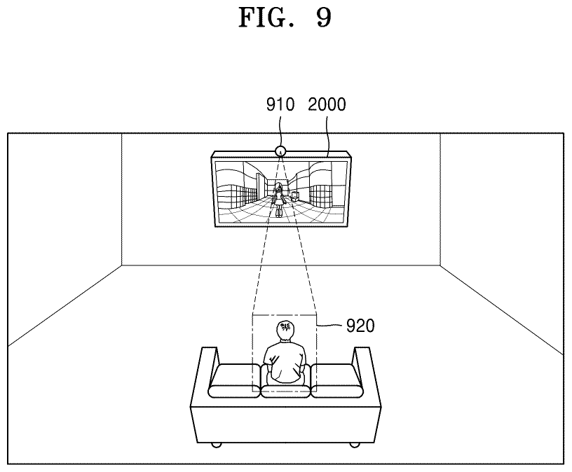

FIG. 9 is a diagram illustrating an example operation in which an example display device obtains a user's position, according to various embodiments of the present disclosure.

For convenience of description, one or more speakers within a user space are not shown in FIG. 9. Referring to FIG. 9, the display device 2000 may include a camera 910. The camera 910 may be one or more cameras. The one or more cameras 910 may be, for example, RGB cameras, RGB-D cameras, stereo cameras, or multi-cameras, but are not limited thereto.

The display device 2000 may use the camera 910 to identify a position of a user 920 using the display device 2000. For example, the display device 2000 may detect and recognize the user 920 in an image obtained using the camera 910, and calculate a distance and a direction from the display device 2000 to the user 920. In various embodiments, the display device 2000 may utilize vision recognition. To recognize the user 920 and determine the position of the user 920 via vision recognition, the display device 2000 may use various known DNN architectures and algorithms, or use an AI model implemented through modifications to the various known DNN architectures and algorithms.

In an embodiment, the display device 2000 may include one or more sensors for determining the position of the user 920. For example, the display device 2000 may include, but is not limited to, an infrared sensor, an ultrasonic sensor, etc.

The display device 2000 may determine output settings of the one or more speakers for the second audio content based on the position of the user 920, thereby providing immersive audio tailored to the characteristics of the user space. For example, if the user 920 is located closer to a second speaker than to a first speaker, the display device 2000 may set an output of the first speaker, which is located farther away from the user 920, to be larger.

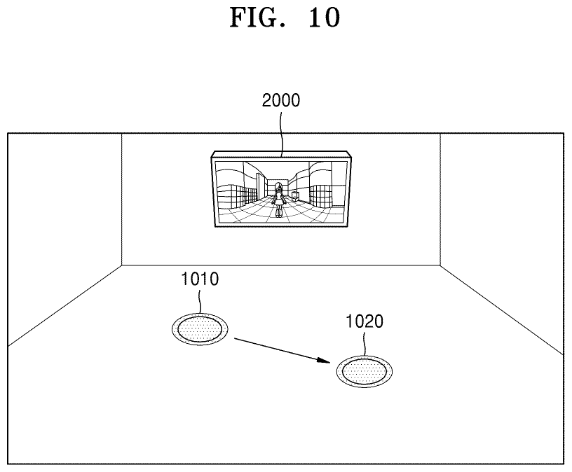

FIG. 10 is a diagram illustrating an example operation in which an example display device updates a user's position, according to various embodiments of the present disclosure.

In an embodiment, as described with reference to FIG. 9, the display device 2000 may identify a user's position. In this case, the display device 2000 may identify and update the user's position in real time. For example, the display device 2000 may track a position of a moving user in real time when the user moves from a first location 1010 to a second location 1020 in a space.

The display device 2000 may update output settings of one or more speakers in real time based on a real-time change in the user's position.

For example, when the user is at the first location 1010 in the space, the display device 2000 may determine output settings of the one or more speakers corresponding to the first location 1010 in order to provide optimal sound for the first location 1010. When the user's position changes to the second location 1020 in the space, the display device 2000 may change the output settings of the one or more speakers to output settings corresponding to the second position 1020 in order to provide optimal sound for the second location 1020.

The display device 2000 may change the output settings of the one or more speakers as the user's position changes in real time, thereby providing the user with immersive audio with an optimal output.

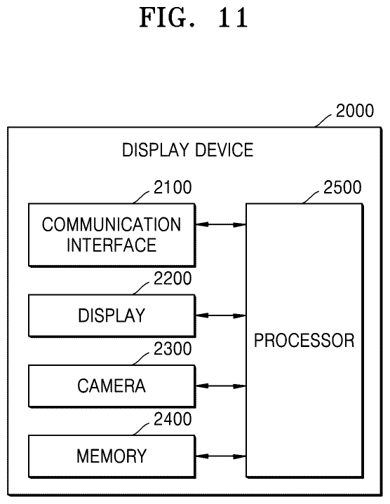

FIG. 11 is a block diagram of a configuration of an example display device according to various embodiments of the present disclosure.

In an embodiment, the display device 2000 may include a communication interface 2100, a display 2200, a camera 2300, memory 2400, and a processor 2500.

The communication interface 2100 may include a communication circuit. The communication interface 2100 may include, for example, a communication circuit capable of performing data communication between the display device 2000 and other devices by using at least one of data communication methods including wired local area network (LAN), wireless LAN, Wi-Fi, Bluetooth, ZigBee, Wi-Fi Direct (WFD), Infrared Data Association (IrDA), Bluetooth Low Energy (BLE), near field communication (NFC), wireless broadband Internet (WiBro), World Interoperability for Microwave Access (WiMAX), Shared Wireless Access Protocol (SWAP), Wireless Gigabit Alliance (WiGig), and radio frequency (RF) communication.

The communication interface 2100 may transmit and receive data for performing operations of the display device 2000 to and from an external electronic device. For example, the display device 2000 may transmit and receive various pieces of data, which are used by the display device 2000 to generate and provide immersive audio content, to and from an external electronic device (e.g., a user's smartphone, a server, etc.) via the communication interface 2100.

The display 2200 may output an image signal on a screen of the display device 2000 according to control by the processor 2500. For example, the display device 2000 may output video content representing a virtual space via the display 2200.

The camera 2300 may obtain a video and/or an image of a space and/or an object captured thereby. The camera 2300 may include one or more cameras. The camera 2300 may include, for example, an RGB camera, a depth camera, an infrared camera, etc., but is not limited thereto. The display device 2000 may use the camera 2300 to identify a user using the display device 2000 and determine a position of the user. The display device 2000 may use the camera 2300 to identify one or more objects (e.g., speakers, etc.) present in the space, and determine a position of the one or more objects. Because the specific types and detailed functions of the camera 2300 may be clearly inferred by one of ordinary skill in the art, a description thereof is omitted.

The memory 2400 may store instructions, data structures, and program code readable by the processor 2500. The memory 2400 may be one or more memories. In disclosed example embodiments, operations performed by the processor 2500 may be implemented by executing instructions or code of a program stored in the memory 2400.

The memory 2400 may include non-volatile memories, such as read-only memory (ROM) (e.g., programmable ROM (PROM), erasable PROM (EPROM), and electrically erasable PROM (EEPROM)), flash memory (e.g., memory card and solid-state drive (SSD)), and analog recording type memory (e.g., hard disk drive (HDD), magnetic tape, and optical disc), and volatile memories, such as random access memory (RAM) (e.g., dynamic RAM (DRAM) and static RAM (SRAM)).

The processor (including, e.g., processing circuitry) 2500 may control all operations of the display device 2000. For example, the processor 2500 may execute one or more instructions of a program stored in the memory 2400 to control all operations performed by the display device 2000 to render immersive audio content. The processor 2500 may be one or more processors (each including, e.g., processing circuitry).

The one or more processors 2500 may include at least one of a central processing unit (CPU), a graphics processing unit (GPU), an accelerated processing unit (APU), a many integrated core (MIC), a digital signal processor (DSP), and a neural processing unit (NPU). The one or more processors 2500 may be implemented in the form of an integrated system on a chip (SoC) including one or more electronic components. The one or more processors 2500 may be each implemented as separate hardware (H/W).

When a method according to an embodiment of the present disclosure includes a plurality of operations, the plurality of operations may be performed by the single processor 2500 or a plurality of processors 2500. For example, when a first operation, a second operation, and a third operation are performed according to a method of an embodiment, the first operation, the second operation, and the third operation may all be performed by a first processor, and the first operation and the second operation may be performed by the first processor (e.g., a general-purpose processor) while the third operation may be performed by a second processor (e.g., a dedicated AI processor). Here, the dedicated AI processor may be an example of the second processor, and perform computations for training/inference of AI models. However, embodiments of the present disclosure are not limited thereto.

The one or more processors 2500 according to the present disclosure may be implemented as a single-core processor or as a multi-core processor.

When a method according to an embodiment of the present disclosure includes a plurality of operations, the plurality of operations may be performed by a single core, or may be performed by a plurality of cores included in the one or more processors 2500.

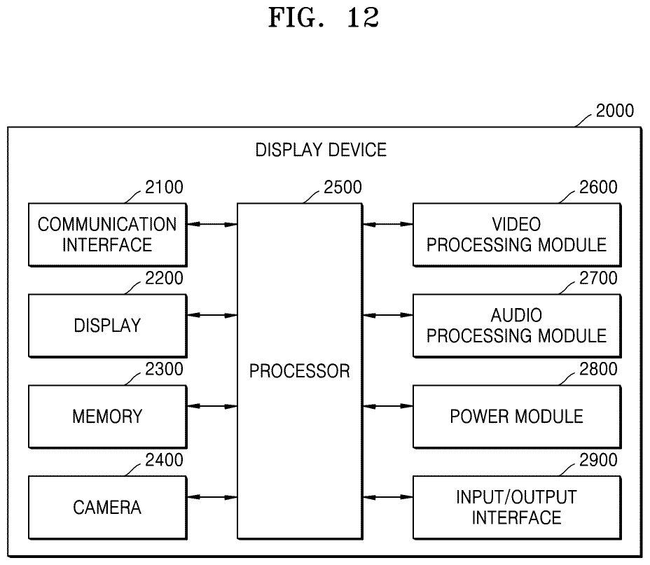

FIG. 12 is a block diagram of a configuration of an example display device according to various embodiments of the present disclosure.

In an embodiment, the display device 2000 may include a communication interface 2100, a display 2200, a camera 2300, memory 2400, a processor 2500, a video processing module 2600, an audio processing module 2700, a power module 2800, and an input/output (I/O) interface 2900.

The communication interface 2100, the display 2200, the camera 2300, the memory 2400, and the processor 2500 of FIG. 12 respectively correspond to the communication interface 2100, the display 2200, the camera 2300, the memory 2400, and the processor 2500 of FIG. 11, and therefore, descriptions provided above are not repeated here.

The video processing module 2600 (including, e.g., video processing circuitry) performs processing on video data played by the display device 2000. The video processing module 2600 may perform various types of image processing, such as decoding, scaling, noise filtering, frame rate conversion, resolution conversion, etc. on the video data. The display 2200 may generate a driving signal by converting an image signal, a data signal, an on-screen display (OSD) signal, a control signal, etc. processed by the processor 2500, and display an image according to the driving signal.

The audio processing module 2700 (including, e.g., audio processing circuitry) performs processing on audio data. The audio processing module 2700 may perform various types of processing, such as decoding, amplification, noise removal, etc., on the audio data. Moreover, the audio processing module 2700 may include a plurality of audio processing units to process audio corresponding to a plurality of pieces of content.

The power module 2800 (including, e.g., power circuitry) supplies, according to control by the processor 2500, power input from an external power source to the internal components of the display device 2000. The power module 2800 may also supply, according to control by the processor 2500, power output from one or more batteries (not shown) located within the display device 2000 to the internal components.

The I/O interface 2900 (including, e.g., interface circuitry) receives video (e.g., a moving image, etc.), audio (e.g., voice, music, etc.), additional information (e.g., an electronic program guide (EPG), etc.), etc. from outside the display device 1200. The I/O interface 2900 may include one of a high-definition multimedia interface (HDMI), a mobile high-definition link (MHL), a universal serial bus (USB), a display port (DP), a Thunderbolt, a video graphics array (VGA) port, an RGB port, a D-subminiature (D-sub), a digital visual interface (DVI), a component jack, and a PC port. The display device 2900 may be connected to one or more speakers via the I/O interface 2900.

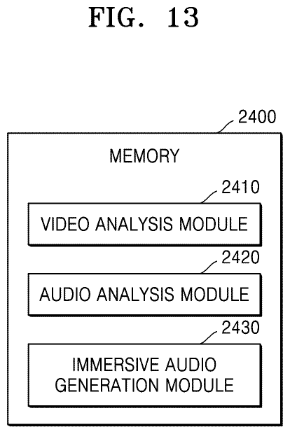

FIG. 13 is a block diagram illustrating modules used by an example display device, according to various embodiments of the present disclosure.

The memory 2400 of FIG. 13 may correspond to the memory of FIGS. 11 and 12.

The memory 2400 may store one or more instructions and programs that cause the display device 2000 to operate to generate immersive audio content. For example, the memory 2400 may store a video analysis module 2410, an audio analysis module 2420, and an immersive audio generation module 2430.

The display device 2000 may perform video analysis on video content using the video analysis module 2410. The display device 2000 may obtain various pieces of data for modifying first audio content to second audio content using various known video analysis algorithms. To perform the video analysis, the display device 2000 may use various known DNN architectures and algorithms, or may use an AI model implemented through modifications to the various known DNN architectures and algorithms.

For example, the display device 2000 may detect and recognize one or more objects in scenes included in the video content. Additionally or alternatively, the display device 2000 may categorize the scenes in the video content. Additionally or alternatively, the display device 2000 may detect a skeleton of a person in the video and categorize an action of the person based on the detected skeleton. Additionally or alternatively, the display device 2000 may detect and recognize a face of the person in the video. Additionally or alternatively, the display device 2000 may extract 2D/3D distance information (e.g., depth information) in the video.

The display device 2000 may perform video metadata analysis on the video content using the video analysis module 2410. Video metadata may be configured in a data format including predefined data elements, but is not limited thereto. The video metadata may include, for example, but is not limited to, at least one of a type of an object present in the video content, a location where a sound is generated, a trajectory of movement of an object, a place, or a time of day.

In an embodiment, when the display device 2000 obtains the video content, the video metadata corresponding to the video content may be obtained together therewith. In an embodiment, the video metadata may be generated by the display device 2000. The display device 2000 may generate and update the video metadata based on a result of the video analysis described above.

The display device 2000 may perform audio analysis on first audio content using the audio analysis module 2420. The display device 2000 may obtain various pieces of data for modifying the first audio content to second audio content by using various known audio analysis algorithms. To perform the audio analysis, the display device 2000 may use various known DNN architectures and algorithms, or use an AI model implemented through modifications to the various known DNN architectures and algorithms.

For example, the display device 2000 may identify sound events included in the first audio content. The display device 2000 may identify, in the first audio content, the time of appearance and disappearance of sounds and sound loudness. Additionally or alternatively, the display device 2000 may classify events corresponding to sounds.

The display device 2000 may perform audio metadata analysis on the first audio content using the audio analysis module. Audio metadata of audio content may be configured in a data format including predefined data elements, but is not limited thereto. The audio metadata may include, for example, but is not limited to, e.g., a time of appearance/disappearance of sounds, sound loudness, a position of an object in a virtual space, a trajectory of movement of a position of an object, a type of an object, and a sound corresponding to an object.

In an embodiment, when the display device 2000 obtains the first audio content, the audio metadata corresponding to the first audio content may be obtained together therewith. In an embodiment, the display device 2000 may supplement and update the audio metadata based on a result of the audio analysis.

The data processing results from the video analysis module 2410 and the audio analysis module 2420 are transmitted to the immersive audio generation module 2430 for processing.

In an embodiment, by using the immersive audio generation module 2430, the display device 2000 may generate the second audio content that is immersive audio by converting the first audio content based on at least one of metadata of the video content, metadata of the first audio content, and spatial information.

The display device 2000 may render the second audio content, which is realistic audio, based on the metadata of the video content and the metadata of the first audio content. For example, the display device 2000 may map the first audio content to objects existing in the virtual space of the video content based on the metadata of the video content (e.g., type of objects present in the video content, location of sound generation, trajectory of object movement, place, time of day, etc.) and the metadata of the first audio content (e.g., time of appearance/disappearance of sounds, sound loudness, positions of objects in the virtual space, trajectory of object position movement, type of objects, etc.). The display device 2000 may render output loudness, output direction, output location, etc. of sounds generated within the virtual space of the video content, based on the arrangement, distance, and orientation of the objects existing in the virtual space. Because the operations of the immersive audio generation module 2430 have already been described with reference to the foregoing drawings, descriptions thereof are not repeated here.

Moreover, the modules stored in the memory 2400 and executed are for convenience of description and are not necessarily limited thereto. Other modules may be added to implement the above-described embodiments, and a single module may be subdivided into a plurality of modules distinguished according to its detailed functions, and some of the above-described modules may be combined to form a single module.

The present disclosure describes a method of generating immersive audio that is customized to a user's space in order to provide content that allows a user to experience a virtual environment. The technical features to be achieved in the present disclosure are not limited to those described above, and other technical features not described will be clearly understood by one of ordinary skill in the art from the description herein.

In an embodiment of the present disclosure, a method, performed by a display device, of providing content may be provided.

The method may include obtaining video content representing a virtual space; obtaining first audio content corresponding to the video content; obtaining spatial information representing audio-related characteristics of a user space; generating second audio content by converting the first audio content based on metadata of the video content, metadata of the first audio content, and the spatial information, wherein the second audio content may include spatially customized audio content; obtaining at least one of positions or specifications of one or more speakers connected to the display device; determining output settings of the one or more speakers for the second audio content, based on the at least one of the positions of the one or more speakers or the specifications of the one or more speakers, and the spatial information; and outputting the second audio content based on the output settings while the video content is displayed on a screen of the display device.

In an embodiment, the metadata of the first audio content may include at least one of a time of appearance/disappearance of sounds, sound loudness, a position of an object in the virtual space, a trajectory of movement of a position of an object, a type of an object, or a sound corresponding to an object.

In an embodiment, the metadata of the video content may include at least one of a type of an object present in the video content, a location where a sound is generated, a trajectory of movement of an object, a place, or a time of day.

In an embodiment, the spatial information may include at least one of information about a 3D spatial layout of the space, information about objects in the space, or information related to a bass trap, a sound absorber, and a sound diffuser in the space.

In an embodiment, the method may include identifying whether metadata of the first audio content exists.

In an embodiment, the method may include generating the metadata of the first audio content based on identifying that the metadata of the first audio content does not exist.

In an embodiment, the generating of the metadata of the first audio content may include generating the metadata of the first audio content based on at least one of the video content, metadata of the video content, or the first audio content.

In an embodiment, the generating of the second audio content may include mapping the first audio content to the virtual space based on the metadata of the video content and the metadata of the first audio content.

In an embodiment, the generating of the second audio content may include modifying, based on the spatial information, the first audio content heard by a character of a user at a position of the character of the user in the virtual space to the second audio content heard by the user at a position of the user in the user space.

In an embodiment, the obtaining of the at least one of the positions or the specifications of the one or more speakers may include receiving a test sound from the one or more speakers using one or more microphones.

In an embodiment, the obtaining of the at least one of the positions or the specifications of the one or more speakers may include determining the positions of the one or more speakers based on the test sound.

In an embodiment, the method may include identifying a position of the user of the display device using one or more sensors.

In an embodiment, the determining of the output settings of the one or more speakers may include determining the output settings of the one or more speakers further based on the position of the user.

In an embodiment, the identifying of the position of the user may include identifying the position of the user in real time.

In an embodiment, the determining of the output settings of the one or more speakers may include changing the output settings of the one or more speakers in real time as the position of the user changes.

In an embodiment of the present disclosure, a display device may be provided.

The display device may include a communication interface, a display, a memory storing one or more instructions, and at least one processor configured to execute the one or more instructions stored in the memory and to cause the display device to obtain video content representing a virtual space; obtain first audio content corresponding to the video content; obtain spatial information representing audio-related characteristics of a user space; generate second audio content, which is spatially customized audio content obtained by being converted into a sound optimized for the user space according to the spatial information, by converting the first audio content based on metadata of the video content, metadata of the first audio content, and the spatial information; obtain at least one of positions or specifications of one or more speakers connected to the display device; determine output settings of the one or more speakers for the second audio content, based on the at least one of the positions of the one or more speakers or the specifications of the one or more speakers, and the spatial information; and output the second audio content based on the output settings while the video content is displayed on a screen of the display device.

In an embodiment, the metadata of the first audio content may include at least one of a time of appearance/disappearance of sounds, sound loudness, a position of an object in the virtual space, a trajectory of movement of a position of an object, a type of an object, or a sound corresponding to an object.

In an embodiment, the metadata of the video content may include at least one of a type of an object present in the video content, a location where a sound is generated, a trajectory of movement of an object, a place, or a time of day.

In an embodiment, the spatial information may include at least one of information about a 3D spatial layout of the space, information about objects in the space, or information related to a bass trap, a sound absorber, and a sound diffuser in the space.

In an embodiment, at least one processor may cause the display device to identify whether metadata of the first audio content exists.

In an embodiment, at least one processor may cause the display device to generate the metadata of the first audio content based on identifying that the metadata of the first audio content does not exist.

In an embodiment, at least one processor may cause the display device to map the first audio content to the virtual space based on the metadata of the video content and the metadata of the first audio content.

In an embodiment, at least one processor may cause the display device to modify, based on the spatial information, the first audio content heard by a character of a user at a position of the character of the user in the virtual space to the second audio content heard by the user at a position of the user in the user space.

In an embodiment, the display device may include one or more microphones.

In an embodiment, at least one processor may cause the display device to receive a test sound from the one or more speakers using the one or more microphones.

In an embodiment, at least one processor may cause the display device to determine the positions of the one or more speakers based on the test sound.

In an embodiment, the display device may include one or more cameras.

In an embodiment, at least one processor may cause the display device to identify a position of the user of the display device using one or more sensors.

In an embodiment, at least one processor may cause the display device to determine the output settings of the one or more speakers further based on the position of the user.

In an embodiment, at least one processor may cause the display device to identify the position of the user in real time.

In an embodiment, at least one processor may cause the display device to change the output settings of the one or more speakers as the position of the user changes in real time.

Moreover, example embodiments of the present disclosure may be implemented in the form of recording media including instructions executable by a computer, such as a program module executed by the computer. The computer-readable recording media may be any available media that are accessible by a computer, and include both volatile and nonvolatile media and both removable and non-removable media. Furthermore, the computer-readable recording media may include computer storage media and communication media. The computer storage media include both volatile and nonvolatile and both removable and non-removable media implemented using any method or technology for storage of information such as computer-readable instructions, data structures, program modules, or other data. The communication media typically embody computer-readable instructions, data structures, program modules, or other data in a modulated data signal.

A computer-readable storage medium may be provided in the form of a non-transitory storage medium. In this regard, the term ‘non-transitory storage medium’ refers to the storage medium not including a signal (e.g., an electromagnetic wave) and is a tangible device, and the term does not differentiate between where data is semi-permanently stored in the storage medium and where the data is temporarily stored in the storage medium. For example, the ‘non-transitory storage medium’ may include a buffer for temporarily storing data.

According to an embodiment, methods according to various embodiments disclosed herein may be included in a computer program product when provided. The computer program product may be traded, as a product, between a seller and a buyer. The computer program product may be distributed in the form of a machine-readable storage medium (e.g., compact disc ROM (CD-ROM)) or distributed (e.g., downloaded or uploaded) on-line via an application store or directly between two user devices (e.g., smartphones). For online distribution, at least a part of the computer program product (e.g., a downloadable app) may be at least transiently stored or temporally generated in a machine-readable storage medium such as a memory of a server of a manufacturer, a server of an application store, or a relay server.

The above description of the present disclosure is provided for illustration, and it will be understood by those of ordinary skill in the art that changes in form and details may be readily made therein without departing from technical idea or essential features of the present disclosure. Accordingly, the above-described embodiments and all aspects thereof are merely examples and are not limiting. For example, each component defined as an integrated component may be implemented in a distributed fashion, and likewise, components defined as separate components may be implemented in an integrated form.

The scope of the present disclosure is defined not by the detailed description thereof but by the following claims, and all the changes or modifications within the meaning and scope of the appended claims and their equivalents will be construed as being included in the scope of the present disclosure.

What is claimed is:

1. A method, performed by a display device, of providing content, the method comprising:
obtaining video content representing a virtual space;
obtaining first audio content corresponding to the video content;
obtaining spatial information representing audio-related characteristics of a user space;
generating second audio content by converting the first audio content based on metadata of the video content, metadata of the first audio content, and the spatial information, wherein the second audio content is spatially customized audio content obtained by being converted into a sound optimized for the user space according to the spatial information;
obtaining at least one of positions or specifications of one or more speakers connected to the display device;
determining output settings of the one or more speakers for the second audio content, based on the at least one of the positions or the specifications of the one or more speakers, and the spatial information; and
outputting the second audio content based on the output settings while the video content is displayed on a screen of the display device.

2. The method of claim 1, wherein the metadata of the first audio content comprises at least one of a time of appearance/disappearance of sounds, sound loudness, a position of an object in the virtual space, a trajectory of movement of a position of an object, a type of an object, and a sound corresponding to an object.

3. The method of claim 2, wherein the metadata of the video content comprises at least one of a type of an object present in the video content, a location where a sound is generated, a trajectory of movement of an object, a place, and a time of day.

4. The method of claim 1, wherein
the generating of the second audio content comprises:
mapping the first audio content to the virtual space based on the metadata of the video content and the metadata of the first audio content; and
modifying, based on the spatial information, the first audio content heard by a character of a user at a position of the character of the user in the virtual space to the second audio content heard by the user at a position of the user in the user space.

5. The method of claim 1, wherein
the obtaining of the at least one of the positions or the specifications of the one or more speakers comprises:
receiving a test sound from the one or more speakers using one or more microphones; and
determining the positions of the one or more speakers based on the test sound.

6. The method of claim 1, further comprising:
identifying a position of the user of the display device using one or more sensors,
wherein the determining of the output settings of the one or more speakers comprises determining the output settings of the one or more speakers further based on the position of the user.

7. The method of claim 6, wherein
the identifying of the position of the user comprises identifying the position of the user in real time, and
the determining of the output settings of the one or more speakers comprises changing the output settings of the one or more speakers as the position of the user changes in real time.

8. A display device comprising:
a communication interface comprising interface circuitry;
a display;
memory storing one or more instructions; and
at least one processor, comprising processing circuitry, configured, individually or collectively, to execute the one or more instructions stored in the memory and to control the display device to:
obtain video content representing a virtual space,
obtain first audio content corresponding to the video content,
obtain spatial information representing audio-related characteristics of a user space,
generate second audio content by converting the first audio content based on metadata of the video content, metadata of the first audio content, and the spatial information, wherein the second audio content is spatially customized audio content obtained by being converted into a sound optimized for the user space according to the spatial information,
obtain at least one of positions or specifications of one or more speakers connected to the display device,
determine output settings of the one or more speakers for the second audio content, based on the at least one of the positions or the specifications of the one or more speakers, and the spatial information, and
output the second audio content based on the output settings while the video content is displayed on a screen of the display device.

9. The display device of claim 8, wherein the metadata of the first audio content comprises at least one of a time of appearance/disappearance of sounds, sound loudness, a position of an object in the virtual space, a trajectory of movement of a position of an object, a type of an object, or a sound corresponding to an object.

10. The display device of claim 9, wherein the metadata of the video content comprises at least one of a type of an object present in the video content, a location where a sound is generated, a trajectory of movement of an object, a place, or a time of day.

11. The display device of claim 8, wherein
at least one processor is configured, individually or collectively, to control the display device to:
map the first audio content to the virtual space based on the metadata of the video content and the metadata of the first audio content, and
modify, based on the spatial information, the first audio content heard by a character of a user at a position of the character of the user in the virtual space to the second audio content heard by the user at a position of the user in the user space.

12. The display device of claim 8, further comprising:
one or more microphones,
wherein at least one processor is configured, individually or collectively, to control the display device to:
receive a test sound from the one or more speakers by using the one or more microphones, and
determine the positions of the one or more speakers based on the test sound.

13. The display device of claim 8, further comprising:
one or more cameras,
wherein at least one processor is configured, individually or collectively, to control the display device to:
identify a position of the user of the display device by using one or more sensors, and
determine the output settings of the one or more speakers further based on the position of the user.

14. The display device of claim 13, wherein
at least one processor is configured, individually or collectively, to control the display device to:
identify the position of the user in real time, and
change the output settings of the one or more speakers as the position of the user changes in real time.

15. A non-transitory computer-readable recording medium having recorded thereon a program which, when executed by at least one processor of a display device, controls the display device to perform operations comprising:
obtaining video content representing a virtual space;
obtaining first audio content corresponding to the video content;
obtaining spatial information representing audio-related characteristics of a user space;
generating second audio content by converting the first audio content based on metadata of the video content, metadata of the first audio content, and the spatial information, wherein the second audio content is spatially customized audio content obtained by being converted into a sound optimized for the user space according to the spatial information;
obtaining at least one of positions or specifications of one or more speakers connected to the display device;
determining output settings of the one or more speakers for the second audio content, based on the at least one of the positions or the specifications of the one or more speakers, and the spatial information; and
outputting the second audio content based on the output settings while the video content is displayed on a screen of the display device.
